(19) United States
(12) Patent Application Publication
(10) Pub. No.: US 2026/0028470 A1
(43) Pub. Date: Jan. 29, 2026

(54) MOLDING COMPOSITION COMPRISING BLACK COLORANT

(71) Applicant: BASF SE, Ludwigshafen am Rhein (DE)

(72) Inventors: Zhen Ke WEI, Shanghai (CN); Huan Bing WANG, Shanghai (CN); Xiao Hu HE, Shanghai (CN); Lu Ping ZHAO, Shanghai (CN)

(21) Appl. No.: 18/995,206

(22) PCT Filed: Jul. 11, 2023
(86) PCT No.: PCT/EP2023/069126

§ 371 Date: Jan. 16, 2025

(30) Foreign Application Priority Data
Jul. 21, 2022 (WO) PCT/CN2022/107103

(51) Int. Cl. C08K 5/3447; C08L 67/03

(52) U.S. Cl. CPC C08K 5/3447; C08L 67/03

(57) ABSTRACT

The present invention relates to a molding composition, which comprises (A) 20 to 98% by weight of a crystalline polymeric material selected from polyamides, polyesters, polyamide-containing blends, polyester-containing blends, or any combinations thereof, (B) 0.01 to 0.5% by weight of a black colorant, (C) 0 to 50% by weight of a reinforcing agent, and (D) 0 to 50% by weight of an amorphous polymeric material selected from polystyrenes, styrene-acrylonitrile copolymers, polyester copolymers, polyamides, or any combinations thereof, and (E) 0 to 10% by weight of one or more additives, each being based on the total weight of the molding composition, wherein the molding composition has an initiate laser transmittance of at least 20% at 1064 nm, and a 10 proportion of an initiate laser transmittance at 780 nm to the initiate laser transmittance at 1064 nm in the range of less than 20%, as measured in form of a 2-mm thick specimen.

### FIELD OF THE INVENTION

The invention relates to a molding composition comprising a black colorant, plastic articles made of the same and use of the molding composition in laser welding.

### BACKGROUND OF THE INVENTION

Plastic materials in black color are very popular in many fields, especially in automotive parts, household appliances, electronic products, etc., due to the classic appearances of the manufactured products. In certain manufacturing processes for plastic articles, it is required that the plastic materials in black color have special optical properties, for example transparency in laser welding processes.

Laser welding, as a tool for jointing plastic parts, is likely to become a popular method. Precondition for the use of laser welding is that the radiation emitted by the laser which is usually in a wavelength range of from 780 to 1200 nm first penetrates a part made of a plastic material having adequate transparency for the laser light of the wavelength as used (i.e., laser-transparent part), and then is absorbed in a thin layer by a second part made of a laser-absorbent plastic material (i.e., laser-absorbent part) which is under the laser-transparent part. Within the thin layer which absorbs the laser light, the laser energy is converted into heat, and this leads to melting within the contact zone and finally to a weld which bonds the laser-transparent part to the laser-absorbent part. Carbon black is mostly often used in plastic materials to provide the laser-absorbent plastic materials as it can provides great economic benefits. For that reason, laser-transparent materials also in black color are generally used to provide a uniform color between the laser-absorbent part and the laser-transparent part. Various laser-transparent colorants can be used to provide the black color in the laser-transparent materials, for example black colorants such as Nigrosin, naphthalocyanine, aniline black, phthalocyanine, porphyrin, perinone, quaterrylene, azo dye, anthraquinone, pyrazolone, squaric acid derivatives and immonium dye; or a mixture of chromatic colorants such as a mixture of red and green colorants to simulate black colorant.

Laser-transparent plastic materials based on common polymers such as polyamide and polyester have been proposed. For example, WO2019216368A1 describes a resin composition having high light transmittance, which is capable of providing a molded article having exceptional laser weldability to an absorbing resin member. The resin composition includes a polyamide resin, a maleic anhydride-modified polyphenylene ether resin, a phosphazene flame retardant, a zinc metal oxide, and an optically transparent dye. WO2011154518A1 describes a laser-transparent PBT composition comprising organic additives wherein inorganic and organic pigments and dyes such as Nigrosine and anthraquinones may be added as colorants.

Parts or articles made of those laser-transparent plastic materials in black color may exhibit good laser transparency, but were found not sufficiently resistant to ultraviolet (UV) rays and undergoing high discoloration upon UV exposure. There is an increasing demand of UV resistant laser-transparent plastic materials with applications of the parts or articles made thereof expanding to expose to sunlight.

It was found by the inventors that the UV resistance of laser-transparent plastic materials cannot be effectively improved via conventional UV absorber and/or UV stabilizer. The UV absorber and/or UV stabilizer is able to protect polymers or resins from discoloration, but not able to prevent the UV-induced discoloration of the laser-transparent colorant as comprised in the plastic materials.

It was also found by the inventors that conventional laser-transparent plastic materials comprising laser-transparent colorants generally exhibit unsatisfactory printability when a laser marking is applied. Laser marking as a tool for labeling products, especially plastic articles, has increased importance in various fields due to the fact that it is a non-contact, rapid and flexible marking process, with durable and abrasion-resistant inscription being provided. The laser useful for the laser marking process may be within a wavelength range of from 150 nm to 2000 nm, for example from 150 nm to 380 nm (i.e., UV laser marking). In such a process, a beam of laser is impinged on the article to be marked, with the laser energy being converted into heat which results in a change in color and transformation of molecular structure or destruction (cut) of the material to produce visible marks in the form of desired patterns or images. Via laser marking, marks may be generated on or beneath the surface of the article.

Therefore, there is a need to provide laser-transparent plastic materials in black color having desired UV resistance, while exhibiting excellent laser transparency. It will be more desirable if the laser-transparent plastic materials in black color could exhibit improved laser marking performance (i.e., printability).

### SUMMARY OF THE INVENTION

It was surprisingly found by the inventors that UV resistant laser-transparent plastic materials based on polyamide and polyester can be provided via using a particular black colorant. It was also found that the laser-transparent plastic materials comprising the particular black colorant could exhibit improved laser printability.

Accordingly, in the first aspect, the present invention provides to a molding composition, which comprises
(A) 20 to 98% by weight of a crystalline polymeric material selected from polyamides, polyesters, polyamide-containing blends, polyester-containing blends, or any combinations thereof,
(B) 0.01 to 0.5% by weight of a black colorant,
(C) 0 to 50% by weight of a reinforcing agent, and
(D) 0 to 50% by weight of an amorphous polymeric material selected from polystyrenes, styrene-acrylonitrile copolymers, polyester copolymers, polyamides, or any combinations thereof, and
(E) 0 to 10% by weight of one or more additives,
each being based on the total weight of the molding composition,
wherein the molding composition has an initiate laser transmittance of at least 20% at 1064 nm, and a proportion of an initiate laser transmittance at 780 nm to the initiate laser transmittance at 1064 nm in the range of less than 20%, as measured in form of a 2-mm thick specimen.

In the second aspect, the present invention provides use of the molding composition as described herein for producing laser-transparent plastic parts or articles.

In the third aspect, the present invention provides articles produced using the molding composition as described herein, for example housings for automotive radars or automotive cameras.

### BRIEF DESCRIPTION OF THE DRAWINGS

FIG. 1 shows laser marking images on Samples C1 to C3, E1 and E2.

### DETAILED DESCRIPTION OF THE INVENTION

The present invention will be described in detail hereinafter. It is to be understood that the present invention can be embodied in many different ways and shall not be construed as limited to the embodiments set forth herein.

The singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner. That is, e.g., further components or elements can be present. The expressions “consists of” or “consisting of” or cognates can be embraced within “comprises” or “comprising” or cognates.

The term “initiate laser transmittance” as used herein is intended to refer to a laser transmittance as measured for a molding specimen as freshly prepared, for example within 72 hours, preferably 24 hours after preparation thereof under protection from moisture.

The term “crystalline polymeric material” as used herein is intended to refer to a polymeric material having crystalline domains between macromolecular chains, as demonstrated by presence of one or more clear endothermic peaks in a melting point measurement via Differential Scanning calorimetry (DSC). The melting enthalpy is expressed relative to the weight of polymer. Herein, a “clear” endothermic peak refers to a peak with a melting enthalpy of at least 5 J/g.

The term “amorphous polymeric material” as used herein is intended to a polymeric material having no crystalline domains or essentially no crystalline domains between macromolecular chains, as demonstrated by lack of an endothermic peak or by the presence of an endothermic peak with a melting enthalpy of less than 5 J/g in a melting point measurement via Differential Scanning calorimetry (DSC).

### Molding Composition

As described hereinabove, the present invention provides a molding composition, which comprises
(A) 20 to 98% by weight of a crystalline polymeric material selected from polyamides, polyesters, polyamide-containing blends, polyester-containing blends, or any combinations thereof,
(B) 0.01 to 0.5% by weight of a black colorant,
(C) 0 to 50% by weight of a reinforcing agent, and
(D) 0 to 50% by weight of an amorphous polymeric material selected from polystyrenes, styrene-acrylonitrile copolymers, polyester copolymers, polyamides, or any combinations thereof, and
(E) 0 to 10% by weight of one or more additives,
each being based on the total weight of the molding composition,
wherein the molding composition has an initiate laser transmittance of at least 20% at 1064 nm, and a proportion of an initiate laser transmittance at 780 nm to the initiate laser transmittance at 1064 nm in the range of less than 20%, as measured in form of a 2-mm thick specimen.

### Component (A)

The molding composition according to the invention comprises, as component (A), a crystalline polymeric material selected from at least one of polyamides, polyesters, polyamide-containing blends, polyester-containing blends.

### Polyamides

Useful polyamides may be those derived from at least one monomer which is selected from the group consisting of lactams, amino acids, the combination of dicarboxylic acid and diamine, and the combination of dicarboxylic acid chloride and diamine.

For example, useful polyamides may be those derived from lactams having from 4 to 30 carbon atoms or amino acids having from 4 to 30 carbon atoms.

Suitable lactams preferably have from 6 to 18 carbon atoms, more preferably from 6 to 12 carbon atoms. Examples of the lactams may include, but are not limited to, caprolactam, enantholactam, caprylolactam, caprinolactam, undecanolactam, laurolactam, or any combinations thereof.

Suitable amino acids preferably have from 6 to 18 carbon atoms, more preferably from 6 to 12 carbon atoms. Examples of the amino acids may include, but are not limited to, 2-aminoadipic acid, 9-aminononanoic acid, 10-aminodecanoic acid, 11-aminoundecanoic acid, 12-aminododecanoic acid, or any combinations thereof.

Examples of useful polyamides may also be those derived from a combination of dicarboxylic acids having from 6 to 32 carbon atoms and diamines having from 4 to 24 carbon atoms or a combination of dicarboxylic acid chlorides having from 6 to 32 carbon atoms and diamines having from 4 to 24 carbon atoms.

Suitable aliphatic diamines preferably have from 4 to 24 carbon atoms, more preferably from 4 to 18 carbon atoms, for example 4, 5, 6, 7, 8, 9, 10, 11, 12, 13 or 14 carbon atoms. The aliphatic diamines may be linear or branched aliphatic diamines. Examples of the aliphatic diamines may include, but are not limited to, 1,4-butanediamine, 1,5-pentanediamine, 1,6-hexanediamine, 1,7-heptanediamine, 1,8-octanediamine, 1,9-nonanediamine, 1,10-decanediamine, 1,11-undecanediamine, 1,12-dodecanediamine, 1,13-tridecanediamine, 1,14-tetradecanediamine, 1,16-hexadecanediamine, 1,18-octadecanediamine, 1,20-eicosanediamine, 1,22-docosanediamine, 2-methylpentane-1,5-diamine, 3-methylpentane-1,5-diamine, 2,5-dimethylhexane-1,6-diamine, 2,4-dimethylhexane-1,6-diamine, 3,3-dimethylhexane-1,6-diamine, 2,2-dimethylhexane-1,6-diamine, 2,2,4-trimethylhexane-1,6-diamine, 2,4,4-trimethylhexane-1,6-diamine, 2,3-dimethylheptane-1,7-diamine, 2,4-dimethylheptane-1,7-diamine, 2,5-dimethylheptane-1,7-diamine, 2,2-dimethylheptane-1,7-diamine, 2-methyloctane-1,8-diamine, 1,3-dimethyloctane-1,8-diamine, 1,4-dimethyloctane-1,8-diamine, 2,4-dimethyloctane-1,8-diamine, 3,4-dimethyloctane-1,8-diamine, 4,5-dimethyloctane-1,8-diamine, 2,2-dimethyloctane-1,8-diamine, 3,3-dimethyloctane-1,8-diamine, 4,4-dimethyloctane-1,8-diamine, 2,4-diethylhexane-1,6-diamine, 5-methylnonane-1,9-diamine, and any combinations thereof.

Suitable dicarboxylic acids may be aliphatic or aromatic and preferably have from 4 to 22 carbon atoms, for example 6, 7, 8, 9, 10, 11, 12, 13, 14, 15, 16, 17, 18, 19 or 20 carbon atoms. Examples of the dicarboxylic acids may include, but are not limited to, adipic acid, pimelic acid, sebacic acid, undecanedioic acid, dodecandioic acid, tridecanedioic acid, tetradecandioic acid, pentadecandioic acid, hexadecanedioic acid, octadecandioic acid, terephthalic acid, isophthalic acid, and any combinations thereof.

Suitable dicarboxylic acid chlorides may be aliphatic or aromatic and preferably have from 4 to 22 carbon atoms, for example 6, 7, 8, 9, 10, 11, 12, 13, 14, 15, 16, 17,18, 19 or 20 carbon atoms. Examples of the dicarboxylic acid chlorides may include, but are not limited to, adipoyl chloride, heptanedioyl dichloride, azelaoyl dichloride, sebacoyl dichloride, undecanedioyl dichloride, and any combinations thereof.

For example, the polyamide as component (A) may be at least one selected from the group consisting of PA6, PA7, PA8, PA9, PA11, PA12, PA410, PA510, PA513, PA515, PA66, PA69, PA610, PA612, PA613, PA614, PA618, PA636, PA88, PA810, PA812, PA1010, PA1012, PA1014, PA1018, PA1210, PA1212, PA1214, PA1218, PA1313, PA1410, PA1412, PA1414, PA1418, PA4T, PA9T, PA 10T, PA 11T, or any combinations thereof, preferably PA6 or PA66.

Useful polyamides preferably have a weight-average molecular weight (Mw) of at least 6,000 more preferably at least 10,000, yet more preferably 15,000 or larger, furthermore preferably 20,000 or larger, as measured by gel permeation chromatography (GPC). The weight-average molecular weight (Mw) is preferably no greater than 35,000, more preferably no greater than 30,000, even more preferably no greater than 26,000. Alternatively or additionally, the useful polyamides may have a relative viscosity in the range of 1.8 to 4.0, as measured in 96% by weight sulfuric acid at 25° C.

In some embodiments according to the present invention, the molding composition according to the invention comprises a polyamide selected from PA6, PA66 or any combinations thereof, preferably PA 66, as component (A).

Polyamide-containing blends

Suitable polyamide-containing blends may be any blends comprising the polyamides as described above, including not only blends of different polyamides, and also blends of a polyamide with a polymer other than polyamide. The blends of different polyamides are particularly useful as the polyamide-containing blends.

### Polyesters

Useful polyesters may be those derived from an aromatic dicarboxylic acid and an aliphatic or aromatic dihydroxy compound. Polyesters of this type are known per se, which comprises an aromatic ring derived from the aromatic dicarboxylic acid, and the aromatic ring is optionally substituted, for example by halogen, such as chlorine or bromine, or by C₁-C₄-alkyl groups, such as methyl, ethyl, iso- or n-propyl, or n-, iso- or tert-butyl groups.

Suitable aromatic dicarboxylic acids are for example 2,6-naphthalenedicarboxylic acid, terephthalic acid and isophthalic acid or a combination thereof.

For example, useful polyesters may be polyalkylene terephthalates, particularly those derived from aliphatic dihydroxy compounds having from 2 to 10 carbon atoms. Preferable aliphatic dihydroxy compounds are diols having from 2 to 6 carbon atoms, such as 1,2-ethanediol, 1,3-propanediol, 1,4-butanediol, 1,6-hexanediol, 1,4-hexanediol, 1,4-cyclohexanediol, 1,4-cyclohexanedimethanol and neopentyl glycol, or any combinations thereof.

Examples of preferable polyesters are polyalkylene terephthalates derived from alkanediols having from 2 to 6 carbon atoms, particularly polyethylene terephthalate (PET), polypropylene terephthalate (PPT), polybutylene terephthalate (PBT), and any combinations thereof, among which PBT is most preferable.

In some embodiments, the molding composition according to the present invention comprises polybutylene terephthalate. The polybutylene terephthalate may be a homo-polyester derived from 1,4-butanediol with terephthalic acid via esterification or with an ester of terephthalic acid via transesterification.

Alternatively, the polybutylene terephthalate may be a co-polyester derived from 1,4-butanediol, terephthalic acid or an ester thereof, and no more than 30 mol % at least one other monomer selected from diols, dicarboxylic acids or a combination thereof. There is no restriction of the type of the co-polyester, including for example block copolymer, random copolymer, graft copolymer and alternating copolymer.

The polybutylene terephthalate preferably comprises no more than 20 mol %, preferably no more than 10 mol %, more preferably no more than 5 mol % of units derived from the at least one other monomer, based on the total monomers constituting the polybutylene terephthalate.

Examples of the other monomer may be aliphatic dicarboxylic acids having up to 20 carbon atoms, cycloaliphatic dicarboxylic acids having 7 to 12 carbon atoms, aromatic dicarboxylic acids having 8 to 16 carbon atoms, or any combinations thereof, preferably selected from the group consisting of succinic acid, glutaric acid, adipic acid, pimelic acid, suberic acid, sebacic acid, azelaic acid, undecanedioic acid, dodecanedioic acid, tridecanedioic acid, tetradecanedioic acid, pentadecanoic acid, hexadecanedioic acid, dimeric acid, isophthalic acid, phthalic acid, 2,6-naphthalene dicarboxylic acid, hexahydrophthalic acid, hexahydroisophthalic acid, hexahydroterephthalic acid, 1,2-cyclopentanedicarboxylic acid, 1,3-cyclopentanedicarboxylic acid, himic acid, 4,4′-diphenyldicarboxylic acid, 4,4′-diphenyletherdicarboxylic acid, 4,4′-diphenylmethanedicarboxylic acid, 4,4′-diphenylketonedicarboxylic acid and any combinations thereof, more preferably succinic acid, glutaric acid, adipic acid, pimelic acid, isophthalic acid, phthalic acid or any combinations thereof.

Examples of the other monomer may be aliphatic glycols having 2 to 12 carbon atoms, cycloaliphatic glycols having 6 to 12 carbon atoms, polyoxyalkylene glycols having a plurality of C₂₋₄ oxyalkylene units, aromatic glycols having 6 to 14 carbon atoms or any combinations thereof, preferably selected from the group consisting of 1,2-ethanediol, 1,2-propanediol, 1,3-propanediol, 1,3-butanediol, 1,6-hexanediol, neopentanediol, 1,3-octanediol, diethylene glycol, triethylene glycol, dipropylene glycol, tripropylene glycol, ditetramethylene glycol, decanediol, 1,4-cyclohexanediol, 1,4-cyclohexanedimethanol, bis-1,4-(hydroxymethyl) cyclohexane, diethylene glycol, polytetramethylene glycol, bisphenols, xylylene glycol, naphthalenediol and any combinations thereof, more preferably ethylene glycol, diethylene glycol or a combination thereof. Useful polybutylene terephthalates preferably have a viscosity in the range from 90 to 170 ml/g, preferably from 100 to 135 ml/g, more preferably from 100 to 120 ml/g, as measured in a 0.005g/ml phenol/1,2-dichlorobenzene solution (1:1 mass ratio), according to ISO 1628-5. Alternatively or additionally, useful polybutylene terephthalates may have a weight-average molecular weight (Mw) of from 60,000 to 100,000 as measured by gel permeation chromatography (GPC).

### Polyester-Containing Blends

Suitable polyester-containing blends may be any blends comprising the polyester as described above, including not only blends of different polyesters, and also blends of a polyester with a polymer other than polyester. The blends of a polyester with a polymer other than polyester are particularly useful as the polyester-containing blends.

The polymeric material may be present in the molding composition according to the present invention in an amount of from 20 to 98% by weight, preferably from 30 to 80% by weight, more preferably from 35 to 75% by weight, for example 35%, 40%, 45%, 50%, 55%, 60%, 65%, 70% or 75%, based on the total weight of the molding composition.

It is to be understood that the amount of the polymeric material as component (A) when mentioned herein is intended to refer to corresponding polymer(s) per se. Commercially available polymeric materials often have been already intentionally added with certain additive(s) to provide one or more desired properties such as color, strength, stability and the like, which additive(s) will not be accounted in the amount of the polymeric material.

### Component (B)

The molding composition according to the present invention comprises a black colorant as component (B), which is laser-transparent and allows the molding composition according to the present invention to have an initiate laser transmittance of at least 20% at 1064 nm, and a proportion of an initiate laser transmittance at 780 nm to the initiate laser transmittance at 1064 nm in the range of less than 20%, as measured in form of a 2-mm thick specimen.

Preferably, the molding composition according to the present invention has an initiate laser transmittance of at least 20% at 1064 nm, and a proportion of an initiate laser transmittance at 780 nm to the initiate laser transmittance at 1064 nm in the range of less than 10%, or even less than 5%.

The laser transmittance of a molding composition as specified herein is determined according to the thermoelectric power measurement or the UV-visible spectrophotometry measurement as described in Examples herein below, preferably the UV-visible spectrophotometry measurement.

The proportion of an initiate laser transmittance at 780 nm to the initiate laser transmittance at 1064 nm is determined specifically according to the UV-visible spectrophotometry measurement as described in Examples herein below.

Useful black colorants may particularly be selected from perylene-derived pigments comprising an isomer of formula Ia, an isomer of formula Ib, or a combination thereof

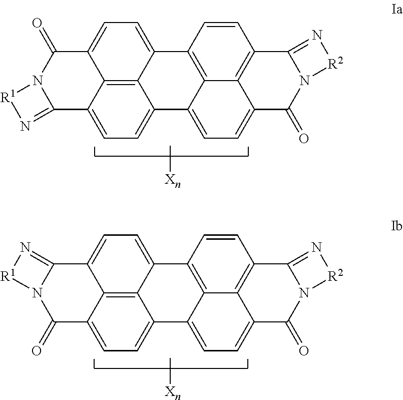

wherein

R¹, R² are each independently 1,2-phenylene, 1,8-, 1,2- or 2,3-naphthylene or 2,3- or 3,4-pyridylene, each being optionally mono- or poly-substituted by C₁-C₁₂-alkyl, C₁-C₆-alkoxy, hydroxyl, nitro and/or halogen,

X is halogen, in particular chlorine or bromine, and

n is from 0 to 4.

In the formulae Ia and Ib, the phenylene, naphthylene and pyridylene radicals as R¹ and R² may be mono- or poly-substituted by C₁-C₁₂-alkyl, especially C₁-C₄-alkyl, C₁-C₆-alkoxy, in particular C₁-C₄-alkoxy, hydroxyl, nitro and/or halogen, especially chlorine or bromine.

Alternatively, the phenylene, naphthylene and pyridylene radicals as R¹ and R² in the formulae Ia and Ib may be unsubstituted. Preferably, R¹, R² are each independently unsubstituted 1,2-phenylene or 1,8-naphthylene radicals. More preferably, R¹ and R² are the same and selected from unsubstituted 1,2-phenylene or 1,8-naphthylene.

Useful perylene-derived pigments particularly comprise an isomer of formula Ia, an isomer of formula Ib, or a combination thereof, wherein R¹, R² are the same and selected from unsubstituted 1,2-phenylene or 1,8-naphthylene, and n is 0.

The perylene-derived pigments may be prepared via known processes, for example as described in the patent application WO2005078023A3, which is incorporated herein by reference.

The black colorant may be present in the molding composition according to the present invention in an amount of from 0.01 to 0.5% by weight, preferably from 0.03 to 0.3% by weight, more preferably from 0.04 to 0.2% by weight, for example 0.05%, 0.1% or 0.2%, based on the total weight of the molding composition.

### Component (C)

Optionally, the molding composition according to the present invention may further comprise a reinforcing agent as component (C), which may be of various types without particular restrictions, such as fiber, whisker, flake and particles.

Useful reinforcing agents may be particularly selected from fibrous reinforcing agents and particulate fillers.

Examples of the fibrous reinforcing agents may include, but are not limited to glass fibers, carbon fibers, boron fibers, asbestos fibers, polyvinyl alcohol fibers, polyester fibers, acrylic fibers, wholly aromatic polyamide fibers, polybenzoxazole fibers, polytetrafluoroethylene fibers, kenaf fibers, bamboo fibers, hemp fibers, bagasse fibers, high strength polyethylene fibers, alumina fibers, silicon carbide fibers, potassium titanate fibers, brass fibers, stainless steel fibers, steel fibers, ceramic fibers, wollastonite fibers, and basalt fibers, among which glass fibers and carbon fibers are particularly preferred.

There is no particular restriction to the fiber length and the fiber diameter of the fibrous reinforcing agent. For example, chopped fibers having a length in the range of from 1 to 10 mm, preferably from 2 to 6 mm, or continuous fibers may be used as starting material of the reinforcing agent. The fibers will be broken down during processing, for example kneading the molding composition, to a length of a few hundreds of microns as present in the obtained moldings. The fiber diameter is generally in the range of from 3 to 20 μm, preferably from 7 to 13 μm.

Examples of the cross-sectional shape of the fibrous reinforcing agent include for example circle, rectangle, ellipse, and other non-circular shapes, among which circle shape is especially preferred. The fibrous reinforcing agent may have a cross section with an aspect ratio in the range of from 1:1 to 5:1.

Glass fibers are particularly useful as the fibrous reinforcing agent for the present invention. The glass fibers may have been surface-treated by a silane coupling agent, such as vinylsilane-based coupling agents, acrylic silane-based coupling agents, epoxysilane-based coupling agents and aminosilane-based coupling agents, preferable aminosilane-based coupling agents. The silane coupling agent may be dispersed in a sizing agent. Examples of the sizing agents are acrylic compounds, acrylic/maleic derivative modified compounds, epoxy compounds, urethane compounds, urethane/maleic derivative modified compounds and urethane/amine modified compounds.

Particulate fillers may be organic or inorganic fillers and have a variety of particle sizes, ranging from particles in dust form to coarse particles. Examples of materials that may be used as inorganic particulate fillers include, but are not limited to kaolin, chalk, wollastonite, talc, calcium carbonate, silicates, titanium dioxide, zinc oxide, graphite, mica, vermiculite, montmorillonite, and glass particles (e.g., glass beads).

In some embodiments, the reinforcing agent as component (C) is selected from glass fibers. The glass fibers may be for example E-glass fibers, A-glass fibers, D-glass fibers, AR-glass fibers, C-glass fibers and S-glass fibers, or any other high modulus or high strength glass fibers such as M-glass fibers and HMG glass fibers.

The reinforcing agent, if comprised, may be present in the molding composition according to the present invention in an amount of from 0.5 to 50% by weight, preferably from 10 to 40% by weight, more preferably from 20 to 40% by weight, for example 20%, 25%, 30%, 35% or 40%, based on the total weight of the molding composition.

### Component (D)

Optionally, the molding composition according to the present invention may further comprise, as component (D), an amorphous polymeric material selected from polystyrenes, styrene-acrylonitrile copolymers, polyester copolymers, polyamides, or any combinations thereof.

Useful amorphous polymeric materials may have a refractive index of at least 1.55, preferably in the range of 1.55 to 1.6, as determined at 25° C. and wavelength of 589 nm according to ASTM D542.

Useful amorphous polystyrenes may be polymers comprising units derived from at least 50% by mole, preferably from at least 60% by mole, most preferably at least 70% by mole of a substituted or unsubstituted styrene monomer.

Examples of the substituted or unsubstituted styrene monomer include, but are not limited to, styrene, alpha-methylstyrene, 2-methylstyrene, 3-methylstyrene, 4-methylstyrene, 2,4-dimethylstyrene, 2,5-dimethylstyrene, para-alpha-dimethylstyrene, 2-ethylstyrene, 3-ethylstyrene, 4-ethyl styrene, 2-isopropyl styrene, 3-isopropyl styrene, 4-isopropyl styrene, ortho-divinylbenzene, meta-divinylbenzene, para-divinylbenzene, ethoxy styrene, chlorostyrene, bromostyrene, dibromostyrene, dichlorostyrene, tribromostyrene, trichlorostyrene, 2-vinylnaphthalene, 2-isopropenylnaphthalene or any combinations thereof,, preferably styrene, alpha-methylstyrene, 4-methylstyrene, chlorostyrene, para-divinylbenzene, bromostyrene, dibromostyrene, trichlorostyrene, 2-vinylnaphthalene, 2-isopropenylnaphthalene or any combinations thereof, more preferably styrene, alpha-methylstyrene, 4-methylstyrene or any combinations thereof.

Generally, useful amorphous polystyrenes may have a weight-average molecular weight (Mw) in the range from 50,000 to 300,000, preferably from 100,000 to 200,000, as measured by GPC.

It is to be understood that the term “polystyrenes” is not intended to encompass “styrene-acrylonitrile copolymers” as used herein.

Useful amorphous styrene-acrylonitrile copolymers are copolymers derived from a substituted or unsubstituted styrene monomer and a substituted or unsubstituted vinyl cyanide monomer. The substituted or unsubstituted styrene monomer may be selected from those species as described hereinabove, preferably styrene, alpha-methyl styrene, 4-methylstyrene, 4-chloro-styrene or any combinations thereof. The vinyl cyanide monomer may be acrylonitrile, methacrylonitrile or a combination thereof.

The styrene-acrylonitrile copolymers may comprise 50 to 99% by weight of the substituted or unsubstituted styrene monomer, and 1 to 50% by weight of the substituted or unsubstituted vinyl cyanide monomer.

The styrene-acrylonitrile copolymers may further comprise a comonomer selected from C₁-C₈ alkyl (meth)acrylates such as methyl (meth)acrylate, ethyl (meth)acrylate, n-butyl (meth)acrylate, t-butyl (meth)acrylate, or other unsaturated carboxylic acid derivatives such as anhydrides or imides thereof, in particular maleic anhydride or n-phenyl maleimide.

Examples of the styrene-acrylonitrile copolymers include, but are not limited to, copoymers of styrene/acrylonitrile (SAN copolymer), a-methylstyrene/acrylonitrile (AMSAN copolymer), styrene/acrylonitrile/maleic anhydride, styrene/acrylonitrile/phenylmaleimide, α-methylstyrene/acrylonitrile/methyl methacrylate, α-methyl-styrene/acrylonitrile/t-butylmethacrylate, styrene/acrylonitrile/t-butylmethacrylate, or any combinations thereof.

The styrene-acrylonitrile copolymers may have a weight-average molecular weight (Mw) of 150,000 to 350,000, preferably 150,000 to 300,000, more preferably 150,000 to 250,000, and most preferably 150,000 to 200,000, as measured by GPC.

Useful amorphous polyester copolymers may be those having at least two different repeating units (RP₁ and RP₂) in a combined amount of at least 55% by mole, preferably at least 80% by mole, more preferably at least 90% by mole, based on the total repeating units of the polyester copolymers. The repeating unit RP₁ is derived from a glycol monomer and a dicarboxylic acid monomer, wherein the dicarboxylic acid monomer includes terephthalic acid and optionally another dicarboxylic acid. The repeating unit RP₂ is derived from a glycol mononer and a dicarboxylic acid monomer. The mole ratio of the glycol moieties in the RP₁ to the glycol moieties in the RP₂ is preferably from 2:8 to 8:2.

The glycol monomers for deriving the units RP₁ and RP₂ may be each independently selected from aliphatic glycols having 2 to 12 carbon atoms, cycloaliphatic glycol having 4 to 12 carbon atoms or any combinations thereof. Examples of the aliphatic glycols having 2 to 12 carbon atoms include ethylene glycol, 1,2-propylene glycol, 1,3-propylene glycol, 1,3-butylene glycol, 1,6-hexanediol, neopentyl glycol, 1,3-octanediol, diethylene glycol, triethylene glycol, dipropylene glycol, tripropylene glycol, ditetramethylene glycol and decanediol, more preferably ethylene glycol, diethylene glycol and neopentyl glycol. Examples of the cycloaliphatic glycols having 4 to 12 carbon atoms include 1,2-cyclobutanediol, 1,3-cyclobutanediol, 1,4-cyclohexanediol, 1,4-cyclohexanedimethanol and bis-1,4-(hydroxymethyl) cyclohexane, more preferably 1,4-cyclohexanediol and 1,4-cyclohexanedimethanol.

The another dicarboxylic acid for deriving the unit RP₁ and the dicarboxylic acid for deriving the unit RP₂ may be each independently selected from aliphatic dicarboxylic acids having 2 to 20 carbon atoms, cycloaliphatic dicarboxylic acids having 7 to 12 carbon atoms, aromatic dicarboxylic acids or any combinations thereof. Examples of the aliphatic dicarboxylic acids having 2 to 20 carbon atoms include succinic acid, glutaric acid, adipic acid, pimelic acid, suberic acid, sebacic acid, azelaic acid, undecanedioic acid, dodecanedioic acid, tridecanedioic acid, tetradecanedioic acid, pentadecanoic acid and hexadecanedioic acid, more preferably succinic acid, glutaric acid, adipic acid and pimelic acid. Examples of the cycloaliphatic dicarboxylic acids having 7 to 12 carbon atoms include 1,2-cyclohexanedicarboxylic acid, 1,3-cyclohexanedicarboxylic acid, 1,4-cyclohexanedicarboxylic acid, 1,2-cyclopentanedicarboxylic acid and 1,3-cyclopentanedicarboxylic acid. Examples of the aromatic dicarboxylic acids include terephthalic acid, isophthalic acid and phthalic acid. It will be understood that the another dicarboxylic acid in RP₁ is other than terephthalic acid.

The glycol monomer for deriving the unit RP₁ is preferably selected from aliphatic glycols having 2 to 12 carbon atoms, more preferably ethylene glycol, diethylene glycol, neopentyl glycol or any combinations thereof. The glycol monomer for deriving the unit RP₂ is preferably selected from cycloaliphatic glycols having 6 to 12 carbon atoms, preferably 1,4-cyclohexanediol, 1,4-cyclohexanedimethanol or a combination thereof. Preferably, the dicarboxylic acid monomer for deriving the unit RP₂ is terephthalic acid and the another dicarboxylic acid monomer for deriving the unit RP₁ is absent.

In some embodiments, the unit RP₁ is derived from ethylene glycol and terephthalic acid and the unit RP₂ is derived from 1,4-cyclohexanedimethanol and terephthalic acid. The molar ratio of ethylene glycol to 1,4-cyclohexanedimethanol is preferably in the range of from 8:2 to 7:3. Such amorphous polyester copolymers are also referred to as PETG (cyclohexanedimethylene glycol modified polyethylene terephthalate).

In some other embodiments, RP₁ is derived from ethylene glycol and terephthalic acid, RP₂ is derived from 1,4-cyclohexanedimethanol and terephthalic. The molar ratio of ethylene glycol to 1,4-cyclohexanedimethanol is preferably 2:8 to 3:7. Such amorphous polyester copolymers are also referred to as PCTG (ethylene glycol modified poly (1,4-cyclohexanedimethylene terephthalate)).

The PETG and PCTG are commercially available, for example from Eastman Chemical Co. and SK Chemicals Co. Ltd, such as Skygreen® S2008 from SK Chemicals Co. Ltd, Easter 6763 and Easter 5445 from Eastman Chemical Co.

Useful amorphous polyamidrs may be for example a block copolymer, a random copolymer, a graft copolymer or an alternating copolymer. Examples of amorphous polyamides may include, but are not limited to, PA6I, PA6T, PA6/PA66, PA66/6, PA6/510, PA56/66, PA56/6, PA5T/66,

PA5T/6, PA6/610, PA6/612, PA6/636, PA6/1010, PA66/410, PA66/510, PA66/610, PA66/612, PA66/1010, PA6T/66, PA6T/6, PA6I/6T, PA56/5T, PAST/56, PA6/6T, PA66/6T and PA6T/6I, among which PA6I, PA6/PA66, PA66/6, PA6T/66, PA66/6T, PA6T/6I and PA6I/6T are preferable, with PA6I, PA6I/6T or a combination thereof being more preferable.

In some particular embodiments, the molding composition according to the present invention comprises an amorphous polymeric material selected from a combination of polystyrene and PETG. The polystyrene and the PETG may be present in a weight ratio in the range of from 10:1 to 1:10, preferably from 5:1 to 1:5, more preferably 3:1 to 1:3, for example 2:1, 1:1, or 1:2. In those embodiments, the molding composition according to the present invention preferably comprises a crystalline polymeric material selected from polyesters or polyester-containing blends as component (A).

In some other particular embodiments, the molding composition according to the present invention comprises an amorphous polymeric material selected from amorphous polyamides, particularly PA6I, PA6I/6T or a combination thereof. In those embodiments, the molding composition according to the present invention preferably comprises a crystalline polymeric material selected from polyamides or polyamide-containing blends as component (A).

The amorphous polymeric material, if comprised, is present in the molding composition according to the present invention in a total amount of from 1 to 50% by weight, preferably from 10 to 40% by weight, more preferably from 15 to 35% by weight, for example 15%, 20%, 25%, 30% or 35%, based on the total weight of the molding composition.

### Component (E)

Optionally, the molding composition according to the present invention may further comprise, as component (E), one or more additives, such as nucleating agent, release agent, impact modifier, thermostabilizer, photostabilizer, compatilizer, lubricant, antioxidant, adhesive adjuvant, plasticizer, colorant other than the component (B), surfactant, flame retardant, flame retardant synergist, coupling agent, antimicrobial agent, antistatic agent, and the like.

The molding composition according to the present invention may for example comprise a nucleating agent. Suitable nucleating agent may be selected from talc, boron nitride, mica, kaolin, alkali metal or alkali earth metal carbonates, bicarbonates or sulfates, alkali metal titanates, silicon nitride or molybdenum disulfide. The nucleating agent is preferably selected from alkali metal carbonates, alkali metal bicarbonates or any combinations thereof.

In some embodiments, the molding composition according to the present invention comprises an alkali metal carbonate or bicarbonate as one of the additives of component (E), preferably sodium carbonate (Na₂CO₃), potassium carbonate (K₂CO₃), sodium bicarbonate (NaHCO₃) and potassium bicarbonate (KHCO₃), among which sodium carbonate is most preferable.

The nucleating agent, if comprised, may be present in an amount of from 0.01 to 10% by weight, preferably from 0.05 to 6% by weight, more preferably from 0.1 to 2% by weight or from 0.1 to 0.5% by weight, for example 0.1%, 0.15%, 0.2%, 0.3%, 0.4% or 0.5% by weight, based on the total weight of the molding composition.

The molding composition according to the present invention may for example comprise a lubricant. Suitable lubricant may be selected from esters or amides of saturated aliphatic carboxylic acids having from 10 to 40 carbon atoms, saturated aliphatic alcohols or amines having from 2 to 40 carbon atoms or any combinations thereof. The lubricant is preferably pentaerythritol esters of fatty acid having 10 to 20 carbon atoms, more preferably pentaerythritol tetrastearate. The lubricant, if comprised, may be present in an amount of from 0.01 to 3% by weight, for example from 0.1 to 2%, or from 0.2 to 1%, based on the total weight of the molding composition.

The molding composition according to the present invention may for example comprise an antioxidant. Suitable antioxidants may be selected from aromatic amine-based antioxidants, hindered phenol-based antioxidants, phosphite-based antioxidants or any combinations thereof, particularly hindered phenol-based antioxidants. Examples of hindered phenol-based antioxidants include α-[3-[3,5-bis(1,1-dimethylethyl)-4-hydroxyphenyl]-1-oxopropyl]-ω-[3-[3,5-bis(1,1-dimethylethyl)-4-hydroxyphenyl]-1-oxopropoxy]poly(oxy-1,2-ethanediyl), 2,4-bis[(octylthio)methyl]-o-cresol, octyl-3,5-di-tert-butyl-4-hydroxy-hydrocinnamate, 3,5-bis(1,1-dimethylethyl)-4-hydroxybenzenepropanoic acid C₇₋₉-branched alkyl ester, 2,4-bis[(dodecylthio)methyl]-o-cresol, 4,4′-butylidene bis-(3-methyl-6-tert-butylphenol), 3,5-bis (1,1-dimethylethyl)-4-hydroxybenzenepropanoic acid octadecyl ester, pentaerythritol tetrakis (3-(3,5-di-tert-butyl-4-hydroxyphenyl) propionate), triethylene glycol bis [3-(3-tert-butyl-5-methyl-4-hydrophenyl)propionate], 2,4-bis(n-octylthio)-6-(4-hydroxy-3,5-di-tert-butylanilino)-1,3,5-triazine, tris-(3,5-di-tert-butyl-4-hydroxybenzyl) isocyanurate, and 2,2-thiodiethylene bis [3-(3,5-di-tert-butyl-4-hydroxyphenyl)propionate]. The antioxidant, if comprised, may be present in an amount of from 0 to 2% by weight, or from 0.01 to 1% by weight, or 0.2 to 0.8% by weight, based on the total weight of the molding composition.

The molding composition according to the present invention may for example comprise an adhesive adjuvant. Suitable adhesive adjuvants may be selected from epoxides, for example epoxidized alkyl esters of fatty acids such as epoxidized linseed oil, epoxidized soybean oil and epoxidized rapeseed oil, epoxy resins such as bisphenol-A resins or any combinations thereof. The adhesive adjuvant, if comprised may be present in an amount of from 0 to 2% by weight, for example from 0.01 to 1% by weight or from 0.2 to 0.8% by weight, based on the total weight of the molding composition.

### Formulations

It will be understood that the any options with respect to species and/or amounts as described herein generally or with preference for the components (A), (B), (C), (D) and (E) may be combined in any way without a restriction. For example, a combination of a general range of the amount of one component with any preferable ranges of the amounts of other components, or a combination of a preferable range of the amount of one component with general ranges of the amounts of the other components, and so on are included in the present invention.

Following embodiments will be described as examples of the formulations of the molding composition according to the present invention.

In some embodiments, the molding composition according to the present invention comprises
(A) 30 to 80% by weight of a crystalline polymeric material selected from polyamides, polyesters, polyamide-containing blends, polyester-containing blends, or any combinations thereof,
(B) 0.03 to 0.3% by weight of a black colorant,
(C) 0 to 50% by weight of a reinforcing agent, and
(D) 0 to 50% by weight of an amorphous polymeric material selected from polystyrenes, styrene-acrylonitrile copolymers, polyester copolymers, polyamides, or any combinations thereof, and
(E) 0 to 10% by weight of one or more additives,
each being based on the total weight of the molding composition,
wherein the molding composition has an initiate laser transmittance of at least 20% at 1064 nm, and a proportion of an initiate laser transmittance at 780 nm to the initiate laser transmittance at 1064 nm in the range of less than 20%, as measured in form of a 2-mm thick specimen.

Preferably, the molding composition according to the present invention comprises
(A) 35 to 75% by weight of a crystalline polymeric material selected from polyamides, polyesters, polyamide-containing blends, polyester-containing blends, or any combinations thereof,
(B) 0.04 to 0.2% by weight of a black colorant,
(C) 0 to 50% by weight of a reinforcing agent, and
(D) 0 to 50% by weight of an amorphous polymeric material selected from polystyrenes, styrene-acrylonitrile copolymers, polyester copolymers, polyamides, or any combinations thereof, and
(E) 0 to 10% by weight of one or more additives,
each being based on the total weight of the molding composition,
wherein the molding composition has an initiate laser transmittance of at least 20% at 1064 nm, and a proportion of an initiate laser transmittance at 780 nm to the initiate laser transmittance at 1064 nm in the range of less than 20%, as measured in form of a 2-mm thick specimen.

In some other embodiments, the molding composition according to the present invention comprises
(A) 30 to 80% by weight of a crystalline polymeric material selected from polyamides, polyesters, polyamide-containing blends, polyester-containing blends, or any combinations thereof,
(B) 0.03 to 0.3% by weight of a black colorant,
(C) 0% to 50% by weight of a reinforcing agent, and
(D) 10 to 40% by weight of an amorphous polymeric material selected from polystyrenes, styrene-acrylonitrile copolymers, polyester copolymers, polyamides, or any combinations thereof, and
(E) 0 to 10% by weight of one or more additives,
each being based on the total weight of the molding composition,
wherein the molding composition has an initiate laser transmittance of at least 20% at 1064 nm, and a proportion of an initiate laser transmittance at 780 nm to the initiate laser transmittance at 1064 nm in the range of less than 20%, as measured in form of a 2-mm thick specimen.

Preferably, the molding composition according to the present invention comprises
(A) 30 to 80% by weight of a crystalline polymeric material selected from polyamides, polyesters, polyamide-containing blends, polyester-containing blends, or any combinations thereof,
(B) 0.03 to 0.3% by weight of a black colorant,
(C) 10% to 40% by weight of a reinforcing agent, and
(D) 10% to 40% by weight of an amorphous polymeric material selected from polystyrenes, styrene-acrylonitrile copolymers, polyester copolymers, polyamides, or any combinations thereof, and
(E) 0 to 10% by weight of one or more additives,
each being based on the total weight of the molding composition,
wherein the molding composition has an initiate laser transmittance of at least 20% at 1064 nm, and a proportion of an initiate laser transmittance at 780 nm to the initiate laser transmittance at 1064 nm in the range of less than 20%, as measured in form of a 2-mm thick specimen.

More preferably, the molding composition according to the present invention comprises
(A) 35 to 75% by weight of a crystalline polymeric material selected from polyamides, polyesters, polyamide-containing blends, polyester-containing blends, or any combinations thereof,
(B) 0.04 to 0.2% by weight of a black colorant,
(C) 10% to 40% by weight of a reinforcing agent, and
(D) 10% to 40% by weight of an amorphous polymeric material selected from polystyrenes, styrene-acrylonitrile copolymers, polyester copolymers, polyamides, or any combinations thereof, and
(E) 0 to 10% by weight of one or more additives,
each being based on the total weight of the molding composition,
wherein the molding composition has an initiate laser transmittance of at least 20% at 1064 nm, and a proportion of an initiate laser transmittance at 780 nm to the initiate laser transmittance at 1064 nm in the range of less than 20%, as measured in form of a 2-mm thick specimen.

In some particular embodiments, the molding composition according to the present invention comprises
(A) 35 to 75% by weight of a crystalline polymeric material selected from polyamides or polyamide-containing blends,
(B) 0.04 to 0.2% by weight of a black colorant selected from perylene-derived pigments comprising an isomer of formula la, an isomer of formula Ib, or a combination thereof as described herein,
(C) 10% to 40% by weight of a reinforcing agent, and
(D) 10% to 40% by weight of an amorphous polymeric material selected polyamides, and
(E) 0 to 10% by weight of one or more additives,
each being based on the total weight of the molding composition,
wherein the molding composition has an initiate laser transmittance of at least 20% at 1064 nm, and a proportion of an initiate laser transmittance at 780 nm to the initiate laser transmittance at 1064 nm in the range of less than 20%, as measured in form of a 2-mm thick specimen.

In some other particular embodiments, the molding composition according to the present invention comprises
(A) 35 to 75% by weight of a crystalline polymeric material selected from polyesters or polyester-containing blends,
(B) 0.04 to 0.2% by weight of a black colorant selected from perylene-derived pigments comprising an isomer of formula Ia, an isomer of formula Ib, or a combination thereof as described herein,
(C) 10% to 40% by weight of a reinforcing agent, and
(D) 10% to 40% by weight of an amorphous polystyrene and a polyester copolymer selected from PETG, PCTG or a combination thereof, and
(E) >0 to 10% by weight of one or more additives, comprising 0.01 to 10% by weight, preferably from 0.05 to 6% by weight, more preferably from 0.1 to 2% by weight or from 0.1 to 0.5% by weight of a nucleating agent,
each being based on the total weight of the molding composition,
wherein the molding composition has an initiate laser transmittance of at least 20% at 1064 nm, and a proportion of an initiate laser transmittance at 780 nm to the initiate laser transmittance at 1064 nm in the range of less than 20%, as measured in form of a 2-mm thick specimen.

In those embodiments described above as examples of the formulations of the molding composition according to the present invention, the proportion of laser transmittance at 780 nm to laser transmittance at 1064nm is preferably in the range of less than 10% or even less than 5%.

The molding composition according to the present invention may be processed by any conventional methods without particular restrictions. For example, the molding composition may be processed by mixing and kneading the components in any conventional kneading apparatuses, such as single-screw or twin-screw extruders, Brabender mixers or Banbury mixers. It is also possible to add into the polymeric material as component (A) the other components as a premix or in sequence to the polyamide resin ingredient, among which the reinforcing agent such as glass fiber, if used, is preferably side-fed into the kneading apparatus. The mixing and kneading may preferably be carried out at a temperature in the range of 220 to 290° C. The obtained mixture may be cooled and comminuted.

Any conventional molding methods may be applied to the molding composition according to the present invention to provide plastic parts or articles, for example injection molding, hollow molding, extrusion molding and press molding.

### Use of the Molding Composition

The molding compositions as described herein are especially useful for manufacturing laser-transparent plastic parts or articles to be processed by laser welding or laser marking.

For laser welding applications, the molding composition may be processed into molded parts and then subjected to any conventional laser welding processes without particular restrictions as the laser-transparent parts to be bonded to the laser-absorbent parts.

For laser-absorbent parts, any laser-absorbent plastic materials may be used without particular restrictions. For example, composite materials or thermosets may be used, but preferably thermoplastic compositions. Suitable thermoplastic compositions are those having adequate laser absorption within the wavelength range as used. Examples of suitable thermoplastic compositions include a thermoplastic polymer and a laser-absorbent filler, preferably those exhibiting a maximum absorption in the wavelength range of from 780 nm to 1100 nm, especially from 900 nm to 1100 nm, for example inorganic pigments such as carbon black, and/or organic pigments or of other light-absorbent fillers such as glass fiber, carbon fiber, silica, alumina, talc, among which carbon black is preferred.

Conventional thermoplastic polymers may be used without restrictions, for example polyamides, olefin polymers, vinyl-based polymers, styrene-based polymers, acrylic polymers, polyphenylene ethers, polyesters, polycarbonates, polyacetals or any combinations thereof.

### Articles

Accordingly, the present invention provides articles produced using the molding composition as described herein.

The articles according to the present invention are useful for various applications, for example in storage containers, electric/electronic equipments, office automation (OA) equipments, home appliances, automotive devices or parts. Particularly preferred applications include automotive hollow parts such as tanks, intake manifolds, camera housings and radar housings, automotive electric parts such as control units and ignition coils, sensor devices, connectors. The articles according to the present invention are particularly suitable as housings for automotive radars or automotive cameras.

### EMBODIMENTS

Various embodiments are listed below. It will be understood that the embodiments listed below can be combined with all aspects and other embodiments in accordance with the scope of the invention.

1. A molding composition, which comprises
(A) 20 to 98% by weight of a crystalline polymeric material selected from polyamides, polyesters, polyamide-containing blends, polyester-containing blends, or any combinations thereof,
(B) 0.01 to 0.5% by weight of a black colorant,
(C) 0 to 50% by weight of a reinforcing agent, and
(D) 0 to 50% by weight of an amorphous polymeric material selected from polystyrenes, styrene-acrylonitrile copolymers, polyester copolymers, polyamides, or any combinations thereof, and
(E) 0 to 10% by weight of one or more additives,
each being based on the total weight of the molding composition,
wherein the molding composition has an initiate laser transmittance of at least 20% at 1064 nm, and a proportion of an initiate laser transmittance at 780 nm to the initiate laser transmittance at 1064 nm in the range of less than 20%, as measured in form of a 2-mm thick specimen.

2. The molding composition according to Embodiment 1, wherein the proportion of an initiate laser transmittance at 780 nm to the initiate laser transmittance at 1064 nm is in the range of less than 10%.

3. The molding composition according to Embodiment 2, wherein the proportion of an initiate laser transmittance at 780 nm to the initiate laser transmittance at 1064 nm is in the range of less than 5%.

4. The molding composition according to any of preceding Embodiments, which comprises, as the component (B), a black colorant selected from perylene-derived pigments comprising an isomer of formula Ia, an isomer of formula Ib, or a combination thereof

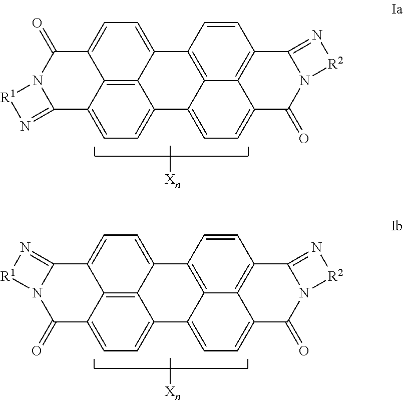

wherein
R¹, R² are each independently 1,2-phenylene, 1,8-, 1,2- or 2,3-naphthylene or 2,3- or 3,4-pyridylene, each being optionally mono- or poly-substituted by C₁-C₁₂-alkyl, C₁-C₆-alkoxy, hydroxyl, nitro and/or halogen,
X is halogen, in particular chlorine or bromine, and
n is from 0 to 4.

5. The molding composition according to Embodiment 4, wherein the phenylene, naphthylene and pyridylene radicals are unsubstituted.

6. The molding composition according to Embodiment 5, wherein R¹ and R² are each independently unsubstituted 1,2-phenylene or 1,8-naphthylene.

7. The molding composition according to Embodiment 4 or 5, wherein R¹ and R² are the same.

8. The molding composition according to any of Embodiments 4 to 7, wherein n is 0.

9. The molding composition according to any of any of preceding Embodiments, which comprises a crystalline polymeric material selected from polyamides or polyamide-containing blends as the component (A).

10. The molding composition according to Embodiment 9, which comprises an amorphous polymeric material selected from polyamides as the component (D).

11. The molding composition according to any of any of preceding Embodiments, which comprises a crystalline polymeric material selected from polyamides or polyamide-containing blends as the component (A) and an amorphous polymeric material selected from PA 6I, PA6I/6T or a combination thereof as the component (D).

12. The molding composition according to any of preceding Embodiments 1 to 8, which comprises a crystalline polymeric material selected from polyesters or polyester-containing blends as the component (A).

13. The molding composition according to Embodiment 12, which comprises a polyalkylene terephthalate or blends containing a polyalkylene terephthalate as the component (A).

14. The molding composition according to any of preceding Embodiments 10 or 11, which comprises a combination of a polyester copolymer selected from PETG, PCTG or a combination thereof and a polystyrene, as the component (D).

15. The molding composition according to Embodiment 14, which comprises a combination of polystyrene and PETG, as the component (D).

16. The molding composition according to any of preceding Embodiments 12 to 15, which comprises a polyalkylene terephthalate or blends containing a polyalkylene terephthalate as the component (A) and a combination of polystyrene and PETG as the component (D).

17. The molding composition according to any of preceding Embodiments, wherein the component (E) comprises a nucleating agent, preferably selected from alkali metal carbonates, alkali metal bicarbonates or any combinations thereof, more preferably sodium carbonate, sodium bicarbonate or a combination thereof.

18. The molding composition according to any of preceding Embodiments, wherein the component (B) comprises a glass fiber.

19. The molding composition according to any of preceding Embodiments, wherein the component (A) is present in an amount of from 30 to 80% by weight.

20. The molding composition according to Embodiment 19, wherein the component (A) is present in an amount of from 35 to 75% by weight.

21. The molding composition according to any of preceding Embodiments, wherein the component (B) is present in an amount of from 0.03 to 0.3% by weight.

22. The molding composition according to Embodiment 21, wherein the component (B) is present in an amount of from 0.04 to 0.2% by weight.

23. The molding composition according to any of preceding Embodiments, wherein the component (C) is present in an amount of from 0.5 to 50% by weight.

24. The molding composition according to Embodiment 23, wherein the component (C) is present in an amount of from 10 to 40% by weight.

25. The molding composition according to Embodiment 24, wherein the component (C) is present in an amount of from 20 to 40% by weight.

26. The molding composition according to any of preceding Embodiments, wherein the component (D) is present in an amount of from 1 to 50% by weight.

27. The molding composition according to Embodiment 26, wherein the component (D) is present in an amount of from 10 to 40% by weight.

28. The molding composition according to Embodiment 27, wherein the component (D) is present in an amount of from 15 to 35% by weight.

29. The molding composition according to any of preceding Embodiments, wherein the component (E) is present and comprises a nucleating agent in an amount of from 0.01 to 10% by weight based on the total weight of the molding composition.

30. The molding composition according to Embodiment 29, wherein the component (E) comprises a nucleating agent in an amount of from 0.05 to 6% by weight based on the total weight of the molding composition.

31. The molding composition according to Embodiment 30, wherein the component (E) comprises a nucleating agent in an amount of from 0.1 to 2% by weight based on the total weight of the molding composition.

32. The molding composition according to Embodiment 31, wherein the component (E) comprises a nucleating agent in an amount of from 0.1 to 0.5% by weight based on the total weight of the molding composition.

33. Use of the molding composition according to any of preceding Embodiments for producing laser-transparent plastic parts or articles.

34. Articles produced using the molding composition according to any of preceding Embodiments 1 to 31, for example housings for automotive radars or automotive cameras.

### EXAMPLES

Aspects of the present invention will be more fully illustrated by the following examples, which are set forth to illustrate certain aspects of the present invention and are not to be construed as limiting thereof.

The preparation and measurements as described herein were all carried out in an air atmosphere under ambient temperature and humidity, unless otherwise specified.

### Materials

PA66: Torzen® U 4800 NC01, crystalline polyamide 66 available from Invista;

PA6I: TM01, amorphous polyamide 6I, available from Shandong Dongchen New Technology Co. Ltd;

PA6I/6T: TI1207, amorphous polyamide 6I/6T, available from Shandong Guangyin New Materials Co. Ltd;

PBT: Ultradur® B 4500, crystalline polybutylene terephthalate available from BASF SE, having a terminal carboxy group content of 34 meq/kg and an intrinsic viscosity of 130 ml/g as measured in a 0.5 wt % strength solution of phenol/o-dichlorobenzene (1:1 mixture) at 25° C.;

PS: POLYREX® PG-383M, amorphous polystyrene available from CHIMEI Corporation;

PETG: SKYGREEN® S2008, available from SK chemicals Co. Ltd;

Glass fibers: (1) ECS 301HP-3-H, E-Glass Fiber available from Chongqing Polycomp International Corp; (2) PBT-NEG-T187H, E-Glass Fiber available from Nippon Electric Glass;

Thermostabilizer: Ultrabatch® 101, Masterbatch of KI and Cul available from BASF;

Lubricant: CRODAMIDE EBS™, ethylene-bis-stearamide available from Croda;

Nigrosine: COLORANT BLACK 500 available from Orient Chemical Co. Ltd;

Macrolex® Green 5B Gran: solvent soluble anthraquinone type green dye, available from LANXESS;

Macrolex® Red E2G Gran: solvent soluble perinone type red dye, available from LANXESS;

Perylene-derived pigment 1: an isomer mixture of black pigments of formulae 1a and 1b in which R¹=R²=1,8-naphthylene and n is 0, as prepared in accordance with the process described in Example 2 of WO2005078023A3;

Perylene-derived pigment 2: an isomer mixture of black pigments of formulae 1a and 1b in which R¹=R²=1,2-phenylene and n is 0, as prepared in accordance with the process described in Example 1 of WO2005078023A3.

### Preparation of Test Specimens

Injection-molded test sheets with dimensions 60 mm×60 mm×2 mm (length×width×thickness) and with edge gating were prepared in accordance with the formulations as specified in the following Tables by injection-molding with parameters set to the following values:

| | Melt temp. | Mold temp. | Injection rate | Hold pressure |
|---|---|---|---|---|
| | [° C.] | [° C.] | [cm³/s] | [bar] |
| Unreinforced | 260 | 60 | 48 | 600 |
| materials | | | | |
| Reinforced | 260 | 80 | 48 | 600 |
| materials | | | | |

The injected-molded sheets were used as specimen sheets for the following measurements.

### Laser Transmittance Measurement

### 1) Thermoelectric Power Measurement

Laser transmittances as shown in the following Table 1 were determined at a wavelength 1064 nm by means of thermoelectric power measurement. The measurement geometry was set up as follows. A beam divider (SQ2 non-polarizing beam divider from Laseroptik GmbH) was used to divide a reference beam of power 1 watt at an angle of 90° from a laser beam (diode-pumped Nd-YAG laser with wavelength 1064 nm, FOBA Vario S50; Laser Source Model DP50) with total power of 2 watts. The reference beam impacted the reference sensor. That portion of the original beam that passed through the beam divider provides the measurement beam likewise with power of 1 watt. This beam was focused to a focal diameter of 0.18 μm via a mode diaphragm (5.0) behind the beam divider. The laser transparency (LT) measurement sensor was positioned 80 mm below the focus. The test sheet was positioned 2 mm above the LT measurement sensor.

The total measurement time was 30 seconds, with the measurement results being determined within the final 5 seconds. The signals from the reference sensor and the measurement sensor were captured simultaneously. The start of the measurement was simultaneous with the insertion of a sample. The measurement was made in the middle of the specimen sheets (point of intersection of the two diagonals).

The laser transmittance (LT) was obtained in accordance with the following equation:

$$LT = \frac{Signal 1}{Signal 2} \times 100 \%$$

wherein

Signal 1 is the signal captured by the measurement sensor; and

Signal 2 is the signal captured by the reference sensor.

Measurement results were reported as an average LT value calculated from five measurements for a sheet. For each material, the average value was calculated on 10 sheets.

### 2) UV-Visible Spectrophotometry Measurement

Laser transmittances as shown in the following Tables were also determined by means of a UV-Visible spectrophotometer (Mettler Evolution™ 220). Measurement results were reported as an average LT value calculated from five measurements for a sheet. For each material, the average value was calculated on 10 sheets.

### Laser Marking and Contrast Measurements

The specimen sheets were marked by a LAISAI laser marking machine of type LS-U from Laser Technology Co., Ltd, using a laser beam under 355 nm. The printability of the specimen sheets was characterized by contrast as obtained in accordance with the following equation,

$$Contrast = \frac{{LS}_{mark}}{{LS}_{background}} \times 100 \%$$

wherein

LSₘₐᵣₖ represents the luminance strength of the brightest mark as generated, and

LS_{background} represents the luminance strength of the unmarked background.

The luminance strengths were measured by Konica Minolta LS-160 luminance meter.

### UV Aging Resistance Measurements

The specimen sheets were subjected to UV exposure in accordance with ISO 4892-2:2013 for the specified durations as shown in the following Tables and characterized for the UV aging resistance by the ΔE_{ab} values and grey scales. The specimen sheets were measured initially, intermediately within 1 hour after the specified durations, and at the end of the exposure.

The ΔEab values were measured according to ASTM D2244-16, by using X-rite Ci6X sphere spectrophotometer under D65 standard light with 10° observer, 8 mm aperture. The results were reported as ΔEab SCE (specular reflection excluded), and ΔEab SCI (specular reflection included).

The grey scales were measured according to GB/T 250-2008, under D65 standard light. The results were reported as rating numbers, with 5 being the best and 1 being the worst.

The formulations and test results for a molding composition comprising a polyamide were summarized in Table 1 below.

TABLE 1

| | | | | | | | | |
|---|---|---|---|---|---|---|---|---|
| Samples | Description | C1 | C2 | C3 | E1 | E2 | E3 | E4 |

Formulations, wt %

| | | | | | | | | |
|---|---|---|---|---|---|---|---|---|
| TORZEN U4800 | PA66 | 68.96 | 68.79 | 68.79 | 68.79 | 68.79 | 53.79 | 53.79 |
| TM01 | PA6I | | | | | | 15 | |
| TI1207 | PA6I/6T | | | | | | | 15 |
| ECS 301HP-3-H | Glass fiber | 30.00 | 30.00 | 30.00 | 30.00 | 30.00 | 30 | 30 |
| ULTRABATCH* 101 | Heat | 0.69 | 0.69 | 0.69 | 0.69 | 0.69 | 0.69 | 0.69 |
| | stabilizer | | | | | | | |
| CRODAMIDE EBS | Lubricant | 0.35 | 0.35 | 0.35 | 0.35 | 0.35 | 0.35 | 0.35 |
| Nigrosine | Black dye | | 0.17 | | | | | |
| Macrolex ® Green 5B Gran | Green dye | | | 0.085 | | | | |
| Macrolex ® Red E2G Gran | Red dye | | | 0.085 | | | | |
| Perylene-derived pigment | Black | | | | 0.17 | | | |
| 1 | pigment | | | | | | | |
| Perylene-derived pigment | Black | | | | | 0.17 | 0.17 | 0.17 |
| 2 | pigment | | | | | | | |
| | | 100 | 100 | 100 | 100 | 100 | 100 | 100 |

Properties

| | | | | | | | | |
|---|---|---|---|---|---|---|---|---|
| blackness L* value | | 64.31 | 25.67 | 26.03 | 28.54 | 26.98 | 26.88 | 26.86 |
| LT¹⁾ at 1064 nm, | % | 47.7 | 10.35 | 49.56 | 26.06 | 26.9 | 37.69 | 38.14 |
| LT²⁾ at 1064 nm | % | 41.77 | 0.18 | 42.26 | 20.46 | 20.26 | | |
| LT²⁾ at 780 nm | % | 34.37 | 0.00 | 31.65 | 0.12 | 0.00 | | |
| Ratio of LT²⁾ at 780 nm to | % | 82.3 | 0 | 74.9 | 0.6 | 0 | | |
| LT²⁾ at 1064 nm | | | | | | | | |
| Contrast of laser marks | | 1.34 | 9.45 | 11.45 | 15.82 | 15.87 | | |

UV aging after 250 hrs

| | | | | |
|---|---|---|---|---|
| ΔEab SCE | 6.3 | 3.7 | 2.6 | 1.5 |
| ΔEab SCI | 1.2 | 0.8 | 0.8 | 0.3 |

UV aging after 500 hrs

| | | | | |
|---|---|---|---|---|
| ΔEab SCE | 12.1 | 7.5 | 3.7 | 2.8 |
| ΔEab SCI | 4.2 | 2.6 | 1.2 | 1.1 |

UV aging after 750 hrs

| | | | | |
|---|---|---|---|---|
| ΔEab SCE | 17 | 14.8 | 6.1 | 5.4 |
| ΔEab SCI | 6.5 | 6.3 | 2.6 | 2.2 |

¹⁾LT values via thermoelectric power measurement
²⁾LT values via UV-visible spectrophotometry measurement

The samples E1 and E2 according to the present invention achieved similar blackness, but provided much higher laser transmittances, compared with the sample C2 comprising nigrosine, a commonly used black colorant. Surprisingly, the samples E1 and E2 exhibited much better UV resistance than the samples C2 and C3 although the latter one exhibited a higher laser transmittance.

The laser transmittance of the samples according to the present invention can further be significantly improved by incorporating the amorphous polymeric materials.

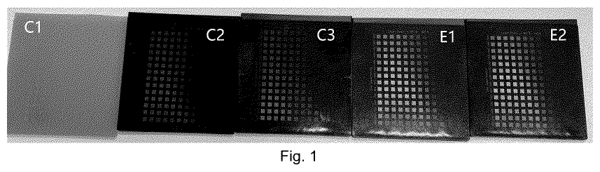

It has also been surprisingly found that the samples E1 and E2 exhibited better laser printability in laser marking process than the samples C2 and C3, as demonstrated via the mark contrast results in Table 1. The better printability of the samples E1 and E2 can also be observed directly from the images of the marks as shown in FIG. 1. The excellent laser printability of the samples E1 and E2 may be attributed to their non-transparency to laser in the UV range, which is unexpected as conventional laser-transparent plastic materials could not exhibit satisfactory laser printability while exhibit desirable laser transmittances.

The formulations and test results for a molding composition comprising a polyester were summarized in Tables 2 and 3 below.

TABLE 2

| Samples | Description | C4 | E5 | E6 | C5 | E7 | E8 | E9 |
|---|---|---|---|---|---|---|---|---|
| Formulations | | | | | | | | |
| Ultradur ® B 4500 | PBT | 69.8 | 69.9 | 69.8 | 39.6 | 39.74 | 39.71 | 39.68 |
| PETG S2008 | PETG | | | | 15.0 | 15.0 | 15.0 | 15.0 |
| POLYREX ® PG-383M | PS | | | | 15.0 | 15.0 | 15.0 | 15.0 |
| Na₂CO₃ | Nucleating | | | | 0.2 | 0.2 | 0.2 | 0.2 |
| | agent | | | | | | | |
| GF PBT-NEG-T187H | Glass fiber | 30.0 | 30.0 | 30.0 | 30.0 | 30.0 | 30.0 | 30.0 |
| Macrolex ® Red E2G Gran | Red dye | 0.1 | | | 0.1 | | | |
| Macrolex ® Green 5B | Green dye | 0.1 | | | 0.1 | | | |
| Gran | | | | | | | | |
| Perylene-derived | Black pigment | | 0.1 | 0.2 | | 0.06 | 0.09 | 0.12 |
| pigment 2 | | | | | | | | |
| | | 100 | 100 | 100 | 100 | 100 | 100 | 100 |

Properties

| | | | | | | | | |
|---|---|---|---|---|---|---|---|---|
| Laser transmittance²⁾ at | % | 23.4 | 23.2 | 22.1 | 56.3 | 57.8 | 57.7 | 56.3 |
| 1064 nm | | | | | | | | |
| Laser transmittance²⁾ at | % | 14.2 | <1 | <1 | 41.5 | <1 | <1 | <1 |
| 780 nm | | | | | | | | |
| Ratio of LT²⁾ at 780 nm to | % | 60.7 | <4.3 | <4.5 | 73.7 | <1.7 | <1.7 | <1.8 |
| LT²⁾ at 1064 nm | | | | | | | | |

²⁾LT values via UV-visible spectrophotometry measurement

It can be seen that the samples E5 and E6 according to the present invention exhibited comparable laser transmittances to the sample C4 comprising a conventional combination of red and green dyes, even at a much lower usage amount (E5 vs. C4). Similar results can also be seen from the comparison between the samples E7 to E9 according to the present invention and the sample C5.

It was also surprisingly found that the laser transmittance can be significantly improved by incorporating the amorphous polymeric materials.

TABLE 3

| | | | | | | | |
|---|---|---|---|---|---|---|---|
| Samples | Description | C6 | C7 | C8 | C9 | C4 | E10 |

Formulations

| | | | | | | | |
|---|---|---|---|---|---|---|---|
| Ultradur ® B 4500 | PBT | 99.82 | 99.32 | 99.32 | 99.32 | 69.8 | 69.95 |
| Tinuvin 234 | UV absorber | | | 0.5 | | | |
| Hostavin N30 P | Light | | 0.5 | | | | |
| | stabilizer | | | | | | |
| Tinuvin 770 DF | Light | | | | 0.5 | | |
| | stabilizer | | | | | | |
| GF PBT-NEG-T187H | Glass fiber | | | | | 30.0 | 30.0 |
| Macrolex ® Red E2G Gran | Red dye | 0.1 | 0.1 | 0.1 | 0.1 | 0.1 | |
| Macrolex ® Green 5B Gran | Green dye | 0.08 | 0.08 | 0.08 | 0.08 | 0.1 | |
| Perylene-derived pigment | Black | | | | | | 0.05 |
| 2 | pigment | | | | | | |
| | | 100 | 100 | 100 | 100 | 100 | 100 |

Properties
UV aging after 250 hrs

| | | |
|---|---|---|
| ΔEab SCE | 10.7 | 3.9 |
| Grey scale | 2-3 | 4 |

UV aging after 500 hrs

| | | | | | | |
|---|---|---|---|---|---|---|
| ΔEab SCE | 14.6 | 13.3 | 12.8 | 13.9 | 14.3 | 6.6 |
| Grey scale | | | | | 1-2 | 3 |

UV aging after 750 hrs

| | | |
|---|---|---|
| ΔEab SCE | 20.6 | 10.2 |
| Grey scale | 1-2 | 3 |

It was found by the inventors that conventional UV absorber or stabilizers for plastic materials (e.g., PBT), such as Tinuvin-234 (benzotriazole UV absorber), Hostavin N30 P (oligomeric hindered amine light stabilizer) and Tinuvin 770 DF (solid basic hindered amine light stabilizer), could not provide effective protection of colorant-containing laser-transparent plastic materials from color shift due to UV aging, as demonstrated via the high ΔEab values of the samples C6to C9. Surprisingly, the UV aging resistance of laser-transparent plastic materials was improved successfully by using the perylene-derived pigment, as demonstrated via lower ΔEab values and higher grey scales (C4 vs. E10).

It will be apparent to one of ordinary skill in the art that various modifications and variations can be made in the present invention without departing from the scope or spirit of the present invention. It is intended that the embodiments and examples be considered as exemplary only. Thus, it is intended that the present invention covers such modifications and variations as come within the scope of the appended claims and their equivalents.

1.-23. (canceled)

24. A molding composition, which comprises:
(A) 20 to 98% by weight of a crystalline polymeric material selected from polyamides, polyesters, polyamide-containing blends, polyester-containing blends, or any combinations thereof,
(B) 0.01 to 0.5% by weight of a black colorant,
(C) 0 to 50% by weight of a reinforcing agent, and
(D) 0 to 50% by weight of an amorphous polymeric material selected from polystyrenes, styrene-acrylonitrile copolymers, polyester copolymers, polyamides, or any combinations thereof, and
(E) 0 to 10% by weight of one or more additives,
each being based on the total weight of the molding composition,
wherein the molding composition has an initiate laser transmittance of at least 20% at 1064 nm, and a proportion of an initiate laser transmittance at 780 nm to the initiate laser transmittance at 1064 nm in the range of less than 20%, as measured in form of a 2-mm thick specimen.

25. The molding composition according to claim 24, wherein the proportion of an initiate laser transmittance at 780 nm to the initiate laser transmittance at 1064 nm is in the range of less than 10% or even less than 5%.

26. The molding composition according to claim 24, which comprises, as the component (B), a black colorant selected from perylene-derived pigments comprising an isomer of formula Ia, an isomer of formula Ib, or a combination thereof 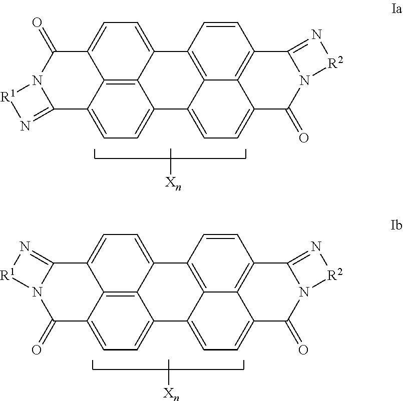
wherein
R¹, R² are each independently 1,2-phenylene, 1,8-, 1,2- or 2,3-naphthylene or 2,3- or 3,4-pyridylene, each being optionally mono- or poly-substituted by C₁-C₁₂-alkyl, C₁-C₆-alkoxy, hydroxyl, nitro and/or halogen,
X is halogen, and
n is from 0 to 4.

27. The molding composition according to claim 26, wherein the phenylene, naphthylene and pyridylene radicals are unsubstituted.

28. The molding composition according to claim 27, wherein R¹ and R² are each independently unsubstituted 1,2-phenylene or 1,8-naphthylene.

29. The molding composition according to claim 26, wherein n is 0.

30. The molding composition according to claim 24, which comprises a crystalline polymeric material selected from polyamides or polyamide-containing blends as the component (A).

31. The molding composition according to claim 24, which comprises an amorphous polymeric material selected from polyamides as the component (D).

32. The molding composition according to claim 24, which comprises a crystalline polymeric material selected from polyamides or polyamide-containing blends as the component (A) and an amorphous polymeric material selected from PA 6I, PA6I/6T or a combination thereof as the component (D).

33. The molding composition according to claim 24, which comprises a crystalline polymeric material selected from polyesters or polyester-containing blends as the component (A)

34. The molding composition according to claim 33, which comprises a polyalkylene terephthalate or blends containing a polyalkylene terephthalate as the component (A).

35. The molding composition according to claim 33, which comprises a combination of a polyester copolymer selected from PETG, PCTG or a combination thereof and a polystyrene, as the component (D).

36. The molding composition according to claim 35, which comprises a combination of polystyrene and PETG, as the component (D).

37. The molding composition according to claim 33, which comprises a polyalkylene terephthalate or blends containing a polyalkylene terephthalate as the component (A) and a combination of polystyrene and PETG as the component (D).

38. The molding composition according to claim 24, wherein the component (E) comprises a nucleating agent selected from alkali metal carbonates, alkali metal bicarbonates or any combinations thereof.

39. The molding composition according to claim 24, wherein the component (B) comprises a glass fiber.

40. The molding composition according to claim 24, wherein the component (A) is present in an amount of from 30 to 80% by weight.

41. The molding composition according to claim 24, wherein the component (B) is present in an amount of from 0.03 to 0.3% by weight.

42. The molding composition according to claim 24, wherein the component (C) is present in an amount of from 0.5 to 50% by weight.

43. The molding composition according to claim 24, wherein the component (D) is present in an amount of from 1 to 50% by weight.

44. The molding composition according to claim 24, wherein the component (E) is present and comprises a nucleating agent in an amount of from 0.01 to 10% by weight, based on the total weight of the molding composition.

45. Use of the molding composition according to claim 24 for producing laser-transparent plastic parts or articles.

46. Articles produced using the molding composition according to claim 24, wherein the articles are housings for automotive radars or automotive cameras.
